(19) United States
(12) Patent Application Publication
(10) Pub. No.: US 2013/0022786 A1
(43) Pub. Date: Jan. 24, 2013

(54) DEVICE HOUSINGS HAVING EXCELLENT SURFACE APPEARANCE

(71) Applicant: Georgios TOPOULOS, Meyrin (CH)

(72) Inventor: Georgios TOPOULOS, Meyrin (CH)

(73) Assignee: E I DU PONT DE NEMOURS AND COMPANY, Wilmington, DE (US)

(21) Appl. No.: 13/550,654

(22) Filed: Jul. 17, 2012

Related U.S. Application Data
(60) Provisional application No. 61/510,151, filed on Jul. 21, 2011.

(51) Int. Cl. C08L 77/06; C08K 7/14

(52) U.S. Cl. 428/141; 524/494

(57) ABSTRACT

The invention relates to resin compositions comprising at least one amorphous semi-aromatic polyamide, at least one semi-crystalline polyamide, and at least one glass reinforcement agent wherein the composition has a good balance of properties in terms of good mechanical properties, excellent surface appearance, and chemical resistance. This invention also relates to the use of such polyamide resins to manufacture device housings.

### CROSS REFERENCE TO RELATED APPLICATIONS

This application claims priority of U.S. Provisional Application No. 61/510,151, filed Jul. 21, 2011.

### FIELD OF THE INVENTION

The present invention relates to the field of polyamide blend compositions. It particularly relates to polyamide blend compositions for manufacturing device housings free of surface line imperfections and having excellent chemical resistance.

### BACKGROUND OF THE INVENTION

Polyamide compositions are desirable for use in a wide range of applications including parts used in automobiles, electrical/electronic articles, household appliances and furniture because of their good mechanical properties, heat resistance, and impact resistance. Additionally, polyamide compositions may be conveniently and flexibly molded into a variety of articles of varying degrees of complexity and intricacy.

As an example, polyamide compositions are particularly suited for making housings for hand held electronic devices, such as mobile telephones, personal digital assistants (PDA), laptop computers, tablet computers, electronic book readers, global positioning system receivers, portable games, radios, cameras, and camera accessories. Such applications are highly demanding applications since they require polyamide compositions that exhibit a good balance of mechanical properties, aesthetical aspect (e.g. surface appearance), and chemical resistance while not interfering with the intended operability of the hand held electronic device, e.g. through absorption of electromagnetic waves.

The art has addressed the technical problem of improving the surface appearance and chemical resistance of polyamide compositions variously:

US 2008/0167415 refers to reinforced polyamide molding materials comprising an aliphatic partly crystalline polyamide and flat glass fibers with elongated shape. Disclosed examples comprise a blend of an amorphous semi-aromatic polyamide (PA 6I/6T) and an aliphatic partly crystalline polyamide (PA66) and flat glass fibers.

US 2008/0132633 refers to polyamide compositions for portable electronic devices comprising a melt-mixed blend of at least one thermoplastic polyamide and at least one fibrous reinforcing agent having a non-circular cross section.

US2009/0005502 refers to polyamide compositions for mobile telephone housings comprising a mixture of long carbon chain aliphatic polyamides optionally blended with at least one semiaromatic polyamide composition and a reinforcing agent.

US 2010/0160008 refers to reinforced polyamide compositions comprising an amorphous semi-aromatic polyamide blended with at least two semi-crystalline polyamides for use in shaped articles having an excellent surface appearance and reduced sink marks.

U.S. Pat. No. 5,750,639 refers to a polyamide composition containing a polyamide resin containing a blend of an aromatic polyamide in which the isophthalic acid constitutes 40 mole percent or less of the mixture, and an aliphatic diamine component derived from a mixture of hexamethylene diamine and 2-methylpentamethylene diamine and at least one polyamide selected from the group consisting of polyamides containing repeat units derived from alipathic dicarboxylic acids and alipathic diamines and polyamides containing repeat units derived from aliphatic aminocarboxylic acids.

However, a need still remains for reinforced polyamide compositions that have a good balance of properties in terms of surface appearance, good mechanical properties, and chemical resistance.

### SUMMARY OF THE INVENTION

There is disclosed and claimed herein is a device housing comprising:
a) 10-30% of an amorphous semi-aromatic polyamide comprising repeat units derived from at least two different aromatic dicarboxylic acids and an aliphatic diamine having from 3 to 18 carbon atoms;
b) 20-40% of a semi-crystalline polyamide comprising repeat units derived from an aliphatic dicarboxylic acid having 10 or more carbon atoms, an aromatic dicarboxylic acid, and an aliphatic diamine having at least 6 carbon atoms with the molar ratio of aliphatic dicarboxylic acid to aromatic dicarboxylic acid of from 4/1 to 3/2;
c) 35-65% of at least one glass reinforcement agent;
   wherein the percentages of components are based on the total weight of (a), (b), and (c); and
   wherein the outer surface of the device housing has a surface line imperfection less than or equal to 4 microns as determined by the surface line imperfection test.

Also disclosed and claimed herein is a device housing comprising:
d) 10-30% of an amorphous semi-aromatic polyamide comprising repeat units derived from an aromatic dicarboxylic acid and an aliphatic diamine having at least 6 carbon atoms;
e) 20-40% of a semi-crystalline polyamide comprising repeat units derived from an aliphatic dicarboxylic acid having 10 or more carbon atoms, an aromatic dicarboxylic acid, and an aliphatic diamine having at least 6 carbon atoms with the molar ratio of aliphatic dicarboxylic acid to aromatic dicarboxylic acid of from 4/1 to 3/2;
f) 35-65% of at least one glass reinforcement agent; wherein the percentages of components are based on the total weight of (d), (e), and (f); and
   wherein the outer surface of the device housing passes the chemical resistance test.

Also described and claimed herein are articles comprising the device housings of the invention.

### DESCRIPTION OF THE FIGURES

FIG. 1 is a picture of test bars showing a rib on the bottom or inner surface of a test bar used in the examples.

FIG. 2 is a diagram showing how the depth of a surface line imperfection is determined by the surface line imperfection test.

FIG. 3 is a picture showing the outer surface of a molded article which passes the chemical resistance tests

FIG. 4 shows the outer surface of a molded article which fails the chemical resistance test.

### DETAILED DESCRIPTION

### Definitions

As used throughout the specification, the phrases “about” and “at or about” are intended to mean that the amount or value in question may be the value designated or some other value about the same. The phrase is intended to convey that similar values promote equivalent results or effects according to the invention.

As used herein, the term “device housing” refers to a manufactured housing, or element of an item or object which at least partly encloses or surrounds the internal components of the device. As used herein, a device housing may be either finished, that is completely manufactured, and thereby suitable for a particular use, or may comprise one or more element(s) or subassembly(ies) that either is partially finished and awaiting assembly with other elements/subassemblies that together will comprise a further subassembly or finished device.

For example, devices having housings as contemplated herein include without limitation and for illustration purposes the following: portable electronic devices such as mobile telephones (cell phones), personal digital assistants (PDA), laptop computers, tablet computers, radios, cameras and camera accessories, watches, calculators, portable music players, global positioning system receivers, portable game players, electronic book readers, and other electronic storage devices.

As used herein, the term “repeat unit” refers to a group of atoms which constitute the repeat unit. This repeat unit reoccurs, is duplicated, or repeats throughout the polymer. A group of atoms making up the repeat unit can be a monomer, an oligomer, or other grouping of atoms.

As used herein, the term “molar ratio” refers to the ratio of the moles of one reactant, product, or repeat unit to the moles of another reactant, product or repeat unit.

As used herein, the term “glass reinforcement agent” refers to a material or materials added to the device housing composition which serve to enhance the mechanical properties of the molded articles, including, but not limited to, charpy impact and tensile strength.

As used herein, the term “outer surface” refers to the surface of a device or article which is part of the outside of the device. It is the surface which can be touched by a person when using the device as intended. The outer surface is the surface of the device an individual sees when looking at the device.

As used herein, the term “surface line imperfection” refers to the maximum depth of the linear depression or dip imperfection on the outer surface of the device housing. This linear depression appears as a line on the outer surface of the device housing when viewed by the unaided human eye.

As used herein, the term “surface line imperfection test” refers to an inspection of the cross section of test bars using an optical microscope and software which determines if line imperfections exist on the outer surface of the test bar, and if present, the depth of the line imperfection on the outer surface of the test bar. Depth measurements are recorded in microns.

As used herein, the term “chemical resistance test” means exposing the molded article to hand cream for 24 hours at 25° C. and after removing the cream, the surface inspected visually by the unaided human eye to determine if the treated surface is substantially the same or was visually different compared to the surface before treatment with cream.

### Overview

In an attempt to improve mechanical properties of articles manufactured from polyamide resins, it has been the conventional practice to add various reinforcements to the resin, like for example glass fibers, glass flakes, carbon fiber, mica, wollastonite, talc, and calcium carbonate to obtain reinforced polyamide compositions. Glass fibers are known to offer excellent dispersion in thermoplastic polymers and lead to good mechanical properties under typical conditions. Moreover, it is important that the articles made from polyamide compositions be able to withstand the rigors of frequent use. It is often desirable that such compositions exhibit good stiffness and impact resistance and that they exhibit excellent surface appearance while simultaneously being resistant to common chemicals used by the consumer. However, the use of glass fibers in polyamide compositions fails to address the issue of surface line imperfections and chemical resistance of housings manufactured using these polyamide compositions.

Semi-crystalline nylons such as polyamide 66 are known to provide excellent mechanical properties. Nevertheless, articles molded from polyamide 66, for example, exhibit significant changes in mechanical properties upon moisture absorption and therefore are not suitable for such applications. Moreover, semi-crystalline polymers exhibit shrinkage during crystallization in the mold which may lead to surface line imperfections in certain areas of molded components. Imperfections include surface lines resulting from the underlying ribs or support structures “telegraphing” through the article onto the outer surface and causing an imperfection in the form of a visible line on the article surface above the underlying rib structure. Another imperfection includes sink marks which are depressions or dimple indentations on the surface of injection molded plastic parts resulting in poor surface quality of the molded part. Sink marks are imperfections that appear as dimples, craters or ripples. Visible surface lines and sink marks are undesirable imperfections and not acceptable because of an accompanying reduction of the aesthetic surface appearance and because these imperfections remain visible after painting or coating the surface of the article. In an attempt to reduce surface imperfections on molded parts prepared using semi-crystalline polyamides, there have been proposed to use or add amorphous polyamides. Nevertheless, commonly used amorphous nylons usually have inferior mechanical properties such as brittleness. Melt blending amorphous polyamides with comparable or lower amount of semi-crystalline polymers is a known way to improve mechanical properties. However such blends do not simultaneously yield satisfactory mechanical properties, outer surfaces free of line imperfections, and chemical resistance.

The following polyamides are useful in manufacturing device housings which are free of visible line imperfections and have excellent chemical resistance.

### Polyamides

Polyamides are condensation products of one or more dicarboxylic acids and one or more diamines, and/or one or more aminocarboxylic acids.

Combinations of amorphous semi-aromatic polyamides blended with semi-crystalline polyamides provide polyamide compositions which have an excellent balance of mechanical properties, ascetically pleasing surface appearance, and chemical resistance.

The amorphous semi-aromatic polyamide of the device housing described herein comprises a mixture of at least two aromatic dicarboxylic acids and at least one aliphatic diamine having 6 to 18 carbon atoms. It is important that the amorphous aromatic polyamide comprise at least two different aromatic dicarboxylic acids. Amorphous polyamides do not possess a distinct melting point and the glass transition temperature (Tg) lies between 110° C. and 180° C.

The semi-crystalline polyamides of the device housing described herein comprise repeat units derived from an aliphatic dicarboxylic acid having 10 or more carbon atoms and an aromatic dicarboxylic acid. The mixture of aliphatic and aromatic dicarboxylic acids are reacted with at least one aliphatic diamine having at least 6 carbon atoms with the molar ratio of aliphatic dicarboxylic acid to aromatic dicarboxylic acid of from 4/1 to 3/2. In order to obtain the necessary balance of mechanical properties, surface appearance, and chemical resistance the semi-crystalline polyamide of the device housing described herein comprises both an aliphatic dicarboxylic acid having 10 or more carbon atoms and an aromatic dicarboxylic acid in a molar ratio of aliphatic dicarboxylic acid to aromatic dicarboxylic acid of from 4/1 to 3/2. It is also important that the diamine reacted with the dicarboxylic acids be aliphatic and have at least 6 carbon atoms

Semi-aromatic polyamides are homopolymers, copolymers, terpolymers, or higher polymers that are derived from monomers containing aromatic groups.

### Amorphous Semi-Aromatic Polyamide Component

The amorphous semi-aromatic polyamide component of the device housing described herein comprises a mixture of at least two different aromatic dicarboxylic acids and at least one aliphatic diamine having 3 to 18 carbon atoms. The aliphatic diamine preferably comprises from 3 to 12 carbon atoms and more preferably 6 to 10 carbon atoms and most preferably 6 carbon atoms.

Suitable aromatic dicarboxylic acids of the amorphous semi-aromatic polyamide component are selected from terephthalic acid (T), isophthalic acid (I), phthalic acid, 2-methylterephthalic acid and naphthalenedicarboxylic acid. A preferred combination of aromatic dicarboxylic acids is terephthalic acid and isophthalic acid. The weight ratio of the two aromatic dicarboxylic acids is from 80-20 to 20-80, preferably 30-70 to 70-30. A most preferred combination is 50-70 weight percent isophthalic acid to 50-30 weight percent terephthalic acid.

Examples of suitable aliphatic diamines of the amorphous semi-aromatic polyamide component include, 3-diaminopropane, 1,4-diaminobutane, 1,5-diaminopentane, 2-ethyldiaminobutane, hexamethylenediamine, 2-methylpentamethylenediamine (MPMD), 2,2,4-trimethylhexamethylenediamine (TMD), 2,4,4-trimethylhexamethylenediamine (IND), bis(4-aminocyclohexyl)methane, 2,2-bis(4-aminocyclohexyl)isopropylidine, 1,4-diaminocyclohexane, 1,3-diaminocyclohexane, 1,4-diaminomethylcyclohexane, 3,3′-dimethyl-4,4′-diamino-dicyclohexylmethane (MACM), 3-aminomethyl-3,5,5-trimethylcyclohexylamine (IPD), bis(4-aminocyclohexyl)methane (PACM), 2,2-bis(p-aminocyclohexyl) propane (PACP), 1,6-diamino-2,2,4-trimethylhexane (ND) and mixtures thereof. Preferably, the aliphatic diamine unit(s) is selected from hexamethylenediamine, PACM, TMD, MACM, and mixtures thereof.

Preferably, the at least one amorphous semi-aromatic polyamide comprised in the compostion of the device housing include PA 6I/6T; PA 6I/6T/PACMI/PACMT; PA 6I/MACMI/MACMT, PA 6I/6T/MACMI, PA 12/MACMT, PA TMDT, PA 6I/6T/IPD, and PA 6/TMDT/6T. More preferably, the at least one amorphous semi-aromatic polyamide is PA 6I/6T; PA 6I/6T/PACMI/PACMT or mixtures thereof and still more preferably the at least one amorphous semi-aromatic polyamides is PA 6I/6T (hexamethylene isophthalamide/hexamethylene terephthalamide).

The numerical suffix of the polyamide specifies the number of carbons donated by the diamine and the diacid. The diamine first and the diacid second. For example, polyamide 66 is a polyamide prepared from hexamethylenediamine and hexane-1,6-dicarboxylic acid (adipic acid) repeat units and polyamide 66/612 copolymer is a mixture of adipic acid and dodecanedioic acid and 1,6-hexamethylenediamine. Blends of two different polyamides may be expressed by known abbreviations, such as PA612/PA6T for a blend of two polyamides, PA6,12 and PA6T.

The well known nomenclature for polyamide monomers, homopolymers, copolymers, terpolymers, etc. as used within U.S. Pat. No. 6,140,459 (herein incorporated by reference) is followed.

The device housing comprises from at or about 10 to at or about 30 wt-% of at least one amorphous semi-aromatic polyamide, more preferably from at or about 10 to at or about 20 wt-%; the weight percentage being based on the total weight of the device housing composition.

### Semi-Crystalline Polyamide Component

The semi-crystalline polyamide component of the device housing as described herein comprises dicarboxylic acid repeat units derived from a mixture of an aliphatic dicarboxylic acid having 10 or more carbon atoms and an aromatic dicarboxylic acid in a molar ratio of aliphatic dicarboxylic acid to aromatic dicarboxylic acid of from 4/1 to 3/2. The mixture of aliphatic and aromatic dicarboxylic acids is reacted with at least one aliphatic diamine having at least 3 carbon atoms.

Examples of aliphatic dicarboxylic acid having 10 or more carbon atoms include sebacic acid; dodecanedioic acid, tetradecanedioic acid and pentadecanedioic acid with dodecanedioic acid and sebacic acid being preferred and dodecanedioic acid most preferred. Examples of aromatic dicarboxylic acids include terephthalic acid (T), isophthalic acid (I), phthalic acid, 2-methylterephthalic acid and naphthalenedicarboxylic with terephthalic acid being preferred.

Suitable aliphatic diamines include, tetramethylenediamine, pentamethylenediamine, hexamethylenediamine, octamethylenediamine, nonamethylenediamine, 2-methylpentamethylenediamine, 2-methyloctamethylenediamine, trimethylhexamethylenediamine decamethylenediamine, undecamethylenediamine, dodecamethylenediamine, tridecamethylenediamine, and the like. Suitable alicyclic diamines include bis(p-aminocyclohexyl)methane. Preferred diamines include hexamethylenediamine.

The device housing comprises from at or about 20 to at or about 40 wt-% of at least one semi-crystalline polyamide, more preferably from at or about 20 to at or about 30 wt-%; the weight percentage being based on the total weight of the device housing composition.

### Glass Reinforcement Agent

The device housing composition comprises at least one glass reinforcement agent. Preferably, the device housing composition comprises from at or about 35 to at or about 65 wt-% of the at least one glass reinforcement agent, more preferably from at or about 40 to at or about 60 wt-% and still more preferably from at or about 50 to at or about 60 wt-%, the weight percentages being based on the total weight of the device housing composition.

Preferably, the at least one glass reinforcement agent is non-circular cross-sectional fibrous glass filler such as those described in U.S. Pat. No. 4,759,784 and in U.S. Pat. No. 4,698,083 and incorporated herein by reference. These fibrous glass fillers are characterized by a non-circular cross section. The non-circular cross section have the shape of, for example, an oval, elliptic, or rectangular.

These kinds of non-circular cross-sectional fibrous glass fillers are described and differentiated from conventional fibrous glass fillers by their cross-sectional aspect ratio and are differentiated from conventional glass flakes by their fibrous nature. The term “fibrous” in the context of the invention means composed of one or multiple filaments of glass. The “cross-sectional aspect ratio” is measured by cutting the fibrous glass filler perpendicularly to its longitudinal axis and measuring the ratio between the major axis of the cross section (i.e. its longest linear dimension) and the minor axis of the cross section (i.e. its shortest linear dimension perpendicular to the major axis). For comparison, circular cross-section fibers that are typically employed have a cross-sectional aspect ratio of about 1. Glass flakes fillers are differentiated from non-circular cross-sectional glass filler by their non-fibrous nature. Due to their specific surface areas which is greater than those of conventional fibrous circular cross-sectional glass fillers, such fibrous non-circular cross-sectional glass fillers provide an improved reinforcing effect relative to circular glass fibers with significant improvement in a) impact resistance, b) warpage stability and c) fluidity during injection molding compared to conventional fibrous glass fillers having a circular cross-sectional shape. The use of fibrous glass filler having a non-circular cross-sectional shape is described in WO2008/070157. Examples of fibrous glass fillers having a cross-sectional aspect ratio of greater than at or about 4 are rectangular or flat-shaped ones. Preferred glass reinforcing agents used in the device housing composition are fibrous glass fillers having a non-circular cross-sectional aspect ratio of greater than at or about 4.

A partial amount of the fibrous non-circular cross-sectional glass fillers can be replaced by others reinforcing agents such as fibrous reinforcing agents having a circular cross section, carbon fiber, glass flakes or particulate reinforcing agents. Preferably, from about 1 wt-% of the fibrous non-circular cross-sectional glass fillers to about 50 wt-%, based on the total weight of the glass reinforcement agent in the composition, can be replaced by the others reinforcing agents in the device housing composition.

### Surface Line Imperfection Test (SLI Test)

Surface line imperfection analysis is performed using an optical microscope to measure the depth of the surface line imperfections or depressions on the outside surface of the article. Visible surface line imperfections or depressions include rib lines on the outside surface of a molded device housing and are detected as visually different from those areas of the housing that do not contain these imperfections when viewed by the unaided human eye. Rib lines are depressions in the surface of the molded article which, if present, are exactly opposite a support rib and may or may not run the entire length of the rib.

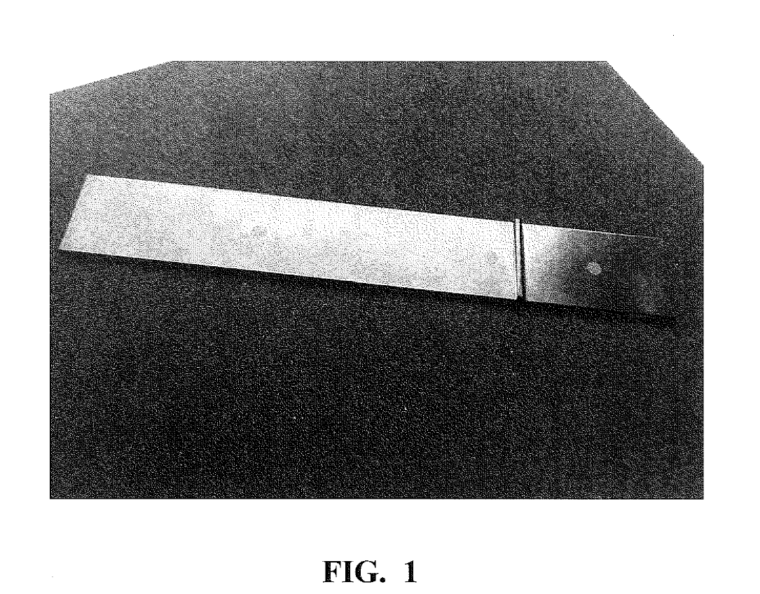

Surface line imperfection analyses were performed on injection molded test bars. The test bars were molded using an Engel ES1750 molding machine from Engel Austria GmbH (melt temperature: about 230° C. to 340° C. or about 30° C. above the polymer Tm; mold temperature: about 90° C. and a hold pressure of 90 MPa). Test bars having dimension of 170×26×2 mm (L×W×H) were molded in a mold having a glossy surface (i.e. no texture). The rib on the test bar has dimensions of 3×26×2 mm (L×W×H). FIG. 1 shows an example of a test bar with rib 1 on the underside or inside of the test bar. The glossy outer surface was obtained by using a mold having a mirror like surface. This was accomplished by standard polishing of the mold's surface. It is preferred that a glossy surface be used because surface imperfections are easier to see visually on a glossy surface although a glossy surface is not necessary for optical testing purposes. The test bars were kept in aluminum sealed bags at 23° C. until testing. The test bars were tested by cutting them in half along the length of the test bar to provide a test bar cross section. A 3 mm length of the outer surface of the cross section test bar, directly opposite from the rib, was examined by optical microscopy for surface line depressions or imperfections. A Leica Wild M10 optical microscope manufactured by Wild-Heerbrugg, Switzerland was used. Leica image management software IM500 was used to capture the images on a computer for analysis. The 3 mm length of the outer surface of the test bar examined was the length of the test bar outer surface directly opposite the rib location which is on the inside surface of the test bar. The 3 mm test length started on the outer surface exactly opposite one side of the rib length and ending at the point exactly opposite the other side of the ribs length. Using the optical microscope and IM500 software, a straight line is superimposed across the 3 mm distance of the outer surface of the test bar cross section opposite the rib. The maximum deviation, sag, or dip of the outer surface of the test bar from this line across the 3 mm length is the depth of the imperfection and is measured in microns.

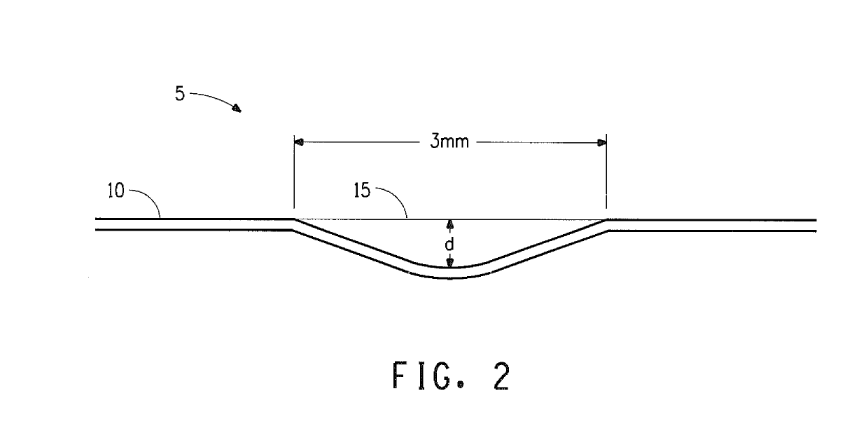

FIG. 2 is a graphical representation of the Surface Line Imperfection Test showing a cross-sectional view of test bar 5 and outer surface 10. The maximum deviation or depth d from the superimposed line 15 is the depth of the imperfection and is recorded in microns.

Surfaces having line imperfections or depressions (rib lines) failed the surface line imperfection test because they were not uniform in appearance and these line imperfections can be seen when viewed with the unaided human eye. When such line imperfections appear on the outer surface of the molded part, it is typically located directly opposite a rib or support structure located on the inner surface of the article. Such line imperfections need not attain any specific length to constitute an imperfection. The characteristic necessary to identify a line imperfection is any deviation, sag, or depression in the outer surface of the molded test bar. A device housing is considered to pass the surface imperfection test if the amount of sag or depression depth (d) is less than 7 microns, preferably less than 4 microns, and more preferably less than 1 micron, and most preferably zero microns, when tested using the surface line imperfection test.

### Chemical Resistance Test

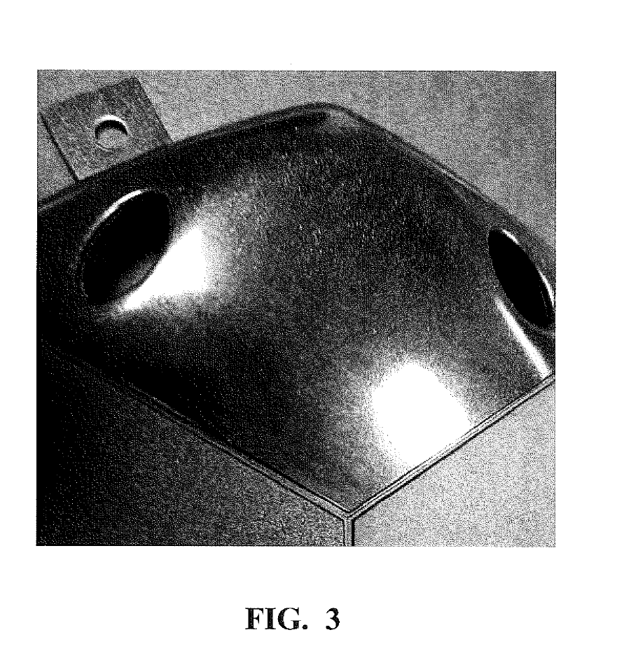

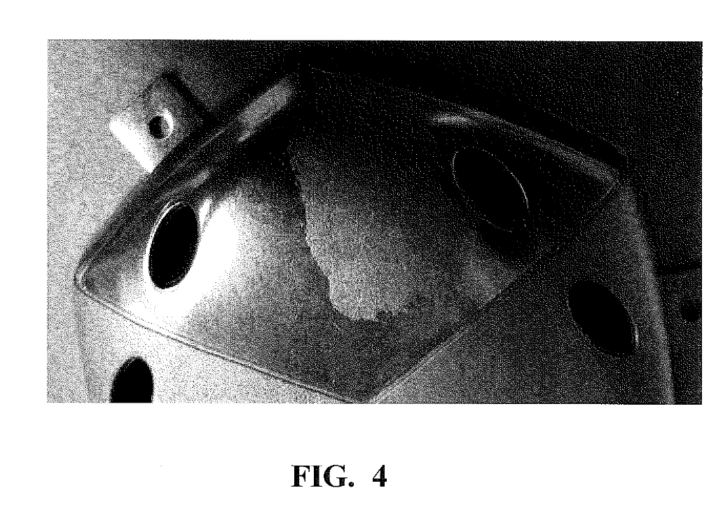

Chemical resistance was determined by exposing a molded article to Nivea® hand cream for 24 hours at 25° C. The cream was applied by hand to an area 1.5 cm² such that the outer surface of the test area on the molded article was not visible (it was hidden by the cream). After exposure for 24 hours, the cream was removed from the article using a paper or cotton towel and the surface inspected visually by the human eye. If the surface area of the article treated with the cream was substantially the same as the surface area before addition of the cream, then a “pass” rating was given. The term “substantially the same” means that the area of the article after treatment with cream, is visually identical to the unaided human eye as the areas of the article which were not treated with the cream. If the surface area of the article treated with cream was visually different than the areas of the article not treated with cream, then a “fail” rating was given. Articles which fail the chemical resistance test have outer surfaces which are not uniform in appearance over the outer surface of the article. The area of the article treated with the hand cream is visually different (nonuniform) than the outer surface areas of the article not treated with cream. FIG. 3 shows the surface of the molded article of the invention before and after the chemical resistance test while FIG. 4 shows the surface of a molded article failing the chemical resistance test after 24 hours exposure to the hand cream. The shape of the article used for the chemical resistance test is not critical and can essentially be any shape or size and can be molded with or without inner ribs.

### Optional Additives

The device housing may further comprise one or more heat stabilizers. The one or more heat stabilizers may be selected from copper salts and/or derivatives thereof such as for example copper halides or copper acetates; divalent manganese salts and/or derivatives thereof and mixtures thereof. Preferably, copper salts are used in combination with halide compounds and/or phosphorus compounds and more preferably copper salts are used in combination with iodide or bromide compounds, and still more preferably, with potassium iodide or potassium bromide. When present, the one or more heat stabilizers are present in an amount from at or about 0.1 to at or about 3 wt-%, or preferably from at or about 0.1 to at or about 1 wt-%, or more preferably from at or about 0.1 to at or about 0.7 wt-%, the weight percentage being based on the total weight of the device housing.

The device housing may further comprise one or more antioxidants such as phosphate or phosphonite stabilizers, hindered phenol stabilizers, hindered amine stabilizers, aromatic amine stabilizers, thioesters, and phenolic based anti-oxidants. When present, the one or more antioxidants comprise from at or about 0.1 to at or about 3 wt-%, or preferably from at or about 0.1 to at or about 1 wt-%, or more preferably from at or about 0.1 to at or about 0.7 wt-%, the weight percentage being based on the total weight of the device housing.

The device housing may further comprise ultraviolet light stabilizers such as hindered amine light stabilizers (HALS), carbon black, substituted resorcinols, salicylates, benzotriazoles, and benzophenones.

The device housing may further comprise modifiers and other ingredients such as for example flow enhancing additives, lubricants, antistatic agents, coloring agents, flame retardants, nucleating agents, crystallization promoting agents and other processing aids known in the polymer compounding art. Examples of optional coloring agents include Zytel® FE3779 from DuPont and GY799 from Clariant.

Fillers, modifiers and other ingredients described above may be present in the device housing in amounts and in forms well known in the art, including in the form of so-called nano-materials where at least one of the dimensions of the particles is in the range of 1 to 1000 nm.

The device housings are prepared from melt-mixed blends, wherein all of the polymeric components are well-dispersed within each other and all of the non-polymeric ingredients are well-dispersed in the blend composition. Any melt-mixing method may be used to combine the polymeric components and non-polymeric ingredients of the present invention. For example, the polymeric components and non-polymeric ingredients may be added to a melt mixer, such as, for example, a single or twin-screw extruder; a blender; a single or twin-screw kneader; or a Banbury mixer, either all at once through a single step addition, or in a stepwise fashion, and then melt-mixed. When adding the polymeric components and non-polymeric ingredients in a stepwise fashion, part of the polymeric components and/or non-polymeric ingredients are first added and melt-mixed with the remaining polymeric components and non-polymeric ingredients being subsequently added and further melt-mixed until a well-mixed composition is obtained.

The well-mixed composition is then used for manufacturing a device housing or article comprising a device housing. The method comprises a step of shaping the well-mixed composition and to the shaped device or article made from the composition. By “shaping” is meant any shaping technique, such as for example extrusion, injection molding, compression molding, blow molding, thermoforming, rotational molding and melt casting, with injection molding being preferred. Examples of shaped articles are automotive parts, electrical/electronic parts, electronic device housings, household appliances, and furniture.

The device housings are particularly suited for manufacturing a portable device housing. By “portable device housing” is meant a cover, or backbone of the device. The device housing may be a single article or comprise two or more components, pieces, or sections which are combined together to form the final article or device. By “backbone” is meant a structural component onto which other components of the device, such as electronics, microprocessors, screens, keyboards and keypads, antennas, and battery sockets are mounted. The backbone may be an interior component that is not visible or only partially visible when looking at the exterior of the electronic device. The device housing may provide protection for internal components of the device or article from impact and contamination and/or damage from environmental agents (such as liquids, dust, and the like). Device housings such as covers may also provide substantial or primary structural support for and protection against impact of certain components having exposure to the exterior of the device such as screens and/or antennas. By “portable device” is meant a device that is designed to be conveniently transported and used in various locations. Representative examples of portable devices include mobile telephones (cell phones), personal digital assistants (PDA), laptop computers, tablet computers, radios, cameras and camera accessories, watches, calculators, portable music players, global positioning system receivers, portable game players, electronic book readers, and other electronic storage devices.

Preferably, articles or devices comprising the device housing include mobile or cell phones, PDA, portable music players, global positioning system receivers, portable game players, and electronic book readers. In a preferred embodiment, the article or device comprising the device housing of the present invention is a cell phone or PDA.

The following examples are provided to describe the invention in further detail. These examples, which set forth a preferred mode presently contemplated for carrying out the invention, are intended to illustrate and not to limit the invention.

### EXAMPLES

The following materials were used for preparing the device housing composition according to the examples (E) and comparative examples (C):
PA6I/6T—a semi-aromatic amorphous polyamide comprising hexamethylenediamine, terephthalic acid (T) and isophtalic acid (I) (T:I=30 wt-%:70 wt-%, the weight percentage being based on the sum of terphthalic acid and isophthalic acid and having an intrinsic viscosity of 0.72.
PA612/6T-A—a semi-crystalline polyamide comprising terephthalic acid and dodecanedioic acid in a weight ratio of terephthalic acid:dodecanedioic acid of 25:75 combined with 1,6-hexamethylenediamine and having a mp of 200° C. and an intrinsic viscosity of 1.2.
PA612/6T-B—a semi-crystalline polyamide comprising terephthalic acid and dodecanedioic acid in a weight ratio of terephthalic acid:dodecanedioic acid of 30:70 combined with 1,6-hexamethylenediamine and having amp of 200° C. and an intrinsic viscosity of 1.2.
Glass reinforcing agent (GRA)—chopped glass fiber strands having an average length of 3 mm, a cross-sectional aspect ratio of about 4, and having a non-circular cross section available as CSG3PA820 supplied by Nitto Boseki Co. Ltd. (Nittobo), Tokyo, Japan.
PA610/6T—a semi-crystalline polyamide comprising terephthalic acid and decanedioic acid in a weight ratio of terephthalic acid:dodecanedioic acid of 25:75 combined with 1,6-hexamethylenediamine and having a mp of 200° C. and an intrinsic viscosity of 1.2.
PA1010—aliphatic semi-crystalline polyamide comprising sebacic acid and decamethylene diamine and having a mp of 200° C. and an intrinsic viscosity of 1.0.
PA610—a polyamide comprising decanedioic acid and 1,6-hexamethylenediamine having a mp of about 224° C. and an intrinsic viscosity of 1.0.
PA6T/66—a semi-crystalline polyamide comprising terephthalic acid and adipic acid in a weight ratio of terephthalic acid:adipic acid of 55:45 combined with 1,6-hexamethylenediamine and having a mp of 305° C., a density of 1.11 g/cm3, and an intrinsic viscosity of 0.9.
Process aid: calcium montanate supplied by Clariant Produkte, Gerstholfen, Germany under the trademark Licomont® CAV102
Antioxidant: N,N′-hexane-1,6-diylbis(3-(3,5-di-tert-butyl-4-hydroxyphenylpropionamide)) supplied by Ciba Specialty Chemicals, Tarrytown, N.Y., USA under the trademark Irganox® 1098.

HALS: Poly[[6-[(1,1,3,3-tetramethylbutyl)amino]-1,3,5-triazine-2,4-diyl][(2,2,6-,6-tetramethyl-4-piperidinyl)imino]-1,6-hexanediyl[(2,2,6,6-tetramethyl-4-piperidinyl)imino]] supplied by Ciba Specialty Chemicals, Tarrytown, N.Y., USA. under the trademark Chimasorb® 944.
CBM is a carbon black masterbatch in polyamide 6 and is available from E. I. du Pont de Nemours & Co., Inc., Wilmington, Del., USA as Zytel® FE3779.
GCM is a gray color masterbatch available from Clariant as GY799.

### Compounding

Device housing compositions of the examples and comparative examples were prepared by melt blending the ingredients shown in Table 1 in a 40 mm twin screw extruder (Berstorff UTS 40) operating at about 230° C. to 320° C., depending on the melting point of the polymer being compounded, using a screw speed of about 300 rpm, a throughput of 110 kg/hour and a melt temperature (measured by a hand thermometer with the thermocouple placed directly in the melt) of about 250° C. to 340° C. The glass fibers were added to the melt through a screw side feeder. Ingredient quantities shown in Table 1 are given in weight percent on the basis of the total weight of the device housing composition.

The compounded mixture was extruded in the form of laces or strands, cooled in a water bath, chopped into granules and placed into sealed aluminum lined bags in order to prevent moisture pick up. The cooling and cutting conditions were adjusted to ensure that the materials were kept below 0.15% of moisture level.

The granules were then used to injection mold test bars which were used for surface line imperfection and chemical resistance testing.

### Mechanical Properties

Tensile modulus was measured according to ISO 527-2/1B/1. Charpy impact measurements (notched and unnotched) were determined using ISO 179 eA. Tensile modulus and charpy impact measurements were done on injection molded ISO bar samples (melt temperature: about 230° C. to 340° C. or about 30° C. above the polymer Tm; mold temperature: about 90° C. and a hold pressure of 90 MPa) with a thickness of the test specimen of 20 mm and a width of 4 mm according to ISO 527. The test specimens were measured at 23° C. dried as molded (DAM) and results expressed as kJ/m² for charpy impact and GPa for tensile modulus.

Mechanical properties were measured for the test specimens made of the device housing composition according to the present invention (E1-E2) and test speciments made of comparative compositions (C1-C10). The results are shown in Table 1.

Nivea hand cream used in the chemical resistance test is available from Beiersdorf Corporation. Nivea hand cream comprises water, paraffin liquid, Cera Microcristallina, Glycerin, Lanolin Alcohol (Eucerit®), Paraffin, Panthenol, Decyl Oleate, Octyldodecanol, Aluminum Stearates, Citric Acid, Magnesium Sulfate, Magnesium Stearate, Parfum, Limonene, Geraniol, Hydroxycitronellal, Linalool, Citronellol, Benzyl Benzoate, and Cinnamyl Alcohol, in order of their concentration in the hand cream formulation.

TABLE 1

| Ingredients | E1 | E2 | C1 | C2 | C3 | C4 | C5 | C6 | C7 | C8 | C9 | C10 |
|---|---|---|---|---|---|---|---|---|---|---|---|---|
| PA612/6T-A | 25.25 | | | | | | | | | | | |
| PA612/6T-B | | 25.25 | | | | | | | | | | |
| PA 6I/6T | 15 | 15 | | | | | 37.2 | 32.55 | 27.9 | 23.25 | 18.6 | 13.95 |
| PA1010 | | | 10 | | 21.5 | 10 | | | | | | |
| PA 610/6T | | | 38.5 | 48.5 | 27 | | | | | | | |
| PA610 | | | | | | 38.5 | | | | | | |
| PA66/6T | | | | | | | 11.3 | 15.95 | 20.6 | 25.25 | 29.9 | 34.55 |
| GRA | 55 | 55 | 50 | 50 | 50 | 50 | 50 | 50 | 50 | 50 | 50 | 50 |
| Processing Aid | 0.3 | 0.3 | 0.3 | 0.3 | 0.3 | 0.3 | 0.3 | 0.3 | 0.3 | 0.3 | 0.3 | 0.3 |
| Antioxidant | 0.2 | 0.2 | 0.2 | 0.2 | 0.2 | 0.2 | 0.2 | 0.2 | 0.2 | 0.2 | 0.2 | 0.2 |
| HALS | 0.4 | 0.4 | 0.4 | 0.4 | 0.4 | 0.4 | 0.4 | 0.4 | 0.4 | 0.4 | 0.4 | 0.4 |
| GCM | 3.85 | 3.85 | | | | | | | | | | |
| CBM | | | 0.6 | 0.6 | 0.6 | 0.6 | 0.6 | 0.6 | 0.6 | 0.6 | 0.6 | 0.6 |
| Physical Properties | | | | | | | | | | | | |
| ^{a}SLI (microns) | 0 | 0 | 23 | 23 | 22 | 22 | 18 | 8 | 13 | 17 | 22 | 23 |
| Chemical Resistance Test | pass | pass | not | pass | not | not | fail | fail | fail | fail | fail | Fail |
| | | | tested | | tested | tested | | | | | | |
| Tensile Modulus (GPa) | 16.4 | 16.3 | 14.3 | 14.8 | 14.6 | 14.5 | 16.7 | 16.8 | 16.8 | 17 | 17 | 17 |
| Charpy Impact* - notched | 17.3 | 17.6 | 16.5 | 17.2 | 17.6 | 16.1 | 17.4 | 16.8 | 19.5 | 18.9 | 17.1 | 16.3 |
| Charpy Impact* - unnotched | 58 | 61 | 71 | 77 | 85 | 75 | 67.7 | 73.2 | 78.4 | 72.7 | 69.9 | 68.8 |

*kJ/m²
^{a}Surface Line Imperfection

All the examples and comparative examples used to manufacture device housings contain the same concentration of GRA, processing aid, HALS, and antioxidant.

Examples E1 and E2 are blends of an amorphous semi-aromatic polyamide (PA 6I/6T) and a semi-crystalline polyamide comprising both an aromatic dicarboxylic acid and a long carbon chain (C10 or greater) dicarboxylic acid (PA 612/6T). This combination results in a device housing having good mechanical properties, no surface line imperfection (zero microns for SLI Test), and passes the chemical resistance test. Comparative examples C5-C10 shows the use of a semi-crystalline polyamide comprising both an aromatic dicarboxylic acid and a short carbon chain (C6) dicarboxylic acid (PA 6616T) provides compositions which fail the chemical resistance test and have SLI Test values of 8-23 microns.

As shown by comparative examples C1 and C3, the use of an amorphous semi-aromatic polyamide (PA610/6T) and a long carbon chain all aliphatic polyamide (PA1010) produce device housing outer surfaces which have very high SLI Test values of 22 and 23 microns respectively. C2 shows the use of a semi-crystalline polyamide comprising a mixture of a long carbon chain dicarboxylic acid and an aromatic dicarboxylic acid with a 6 carbon atom diamine (PA610/6T) which passes the chemical resistance test but has an SLI Test value of 23 microns. C4 reveals the use of a blend of two aliphatic polyamides (PA1010 and PA610) provides a device housing surface which has an SLI Test value of 22 microns. C5-C7 show the use of various concentrations of an amorphous semi-aromatic polyamide (PA 6I/6T) with a semi-crystalline polyamide comprising an aliphatic and an aromatic dicarboxylic acid reacted with a short chain aliphatic amine (PA 66/6T) provides a device housing surface which have SLI Test values of 8-18 microns and fail the chemical resistance test.

Comparative examples C9-C10 are blends using the same polyamide blends as C5-C8, but at lower concentrations of amorphous semi-aromatic polyamides. The lower concentration of amorphous semi-aromatic polyamide in the composition causes the device housing outer surface to fail the chemical resistance test and results in very high SLI Test values of 22-23 microns. Comparative examples C5-C10 clearly show that even when using the same polyamides, the ratio of polyamides in the composition can have a dramatic effect on the surface appearance and chemical resistance of the composition.

What is claimed is:

1. A device housing comprising,
a) 10-30% of an amorphous semi-aromatic polyamide comprising repeat units derived from at least two different aromatic dicarboxylic acids and an aliphatic diamine having from 3 to 18 carbon atoms;
b) 20-40% of a semi-crystalline polyamide comprising repeat units derived from an aliphatic dicarboxylic acid having 10 or more carbon atoms, an aromatic dicarboxylic acid, and an aliphatic diamine having at least 6 carbon atoms with the molar ratio of aliphatic dicarboxylic acid to aromatic dicarboxylic acid of from 4/1 to 3/2;
c) 35-65% of at least one glass reinforcement agent;
wherein the percentages of components are based on the total weight of (a), (b), and (c); and
wherein the outer surface of the device housing has a surface line imperfection less than or equal to 4 microns as determined by the surface line imperfection test.

2. A device housing comprising,
a) 10-30% of an amorphous semi-aromatic polyamide comprising repeat units derived from at least two different aromatic dicarboxylic acids and an aliphatic diamine having from 3 to 18 carbon atoms;
b) 20-40% of a semi-crystalline polyamide comprising repeat units derived from an aliphatic dicarboxylic acid having 10 or more carbon atoms, an aromatic dicarboxylic acid, and an aliphatic diamine having at least 6 carbon atoms with the molar ratio of aliphatic dicarboxylic acid to aromatic dicarboxylic acid of from 4/1 to 3/2;
c) 35-65% of at least one glass reinforcement agent;
wherein the percentages of components are based on the total weight of (a), (b), and (c); and
wherein the outer surface of the device housing passes the chemical resistance test.

3. The device housing of claim 1 or 2 wherein said amorphous semi-aromatic polyamide (a) comprises 10 to 20 weight percent of the polyamide composition.

4. The device housing of claim 1 or 2 wherein said semi-crystalline polyamide (b) comprises 20 to 30 weight percent of the polyamide composition.

5. The device housing of claim 1 or 2 wherein said glass reinforcement agent (c) comprises 50 to 60 weight percent of the polyamide composition.

6. The device housing of claim 1 or 2 wherein said aromatic dicarboxylic acid is selected from terephthalic acid (T), isophthalic acid (I), phthalic acid, 2-methylterephthalic acid, naphthalenedicarboxylic acid or mixtures thereof.

7. The device housing of claim 6 wherein said aromatic dicarboxylic acid is a mixture of terephthalic acid (T) and isophthalic acid (I).

8. The device housing of claim 1 or 2 wherein the glass reinforcement agent (c) is fibrous non-circular cross-sectional glass.

9. The device housing of claims 1 or 2 wherein the outer surface of the device housing has a surface line imperfection less than or equal to 1 micron.

10. An article comprising the device housing of claim 1 or 2 in the form of a portable electronic device.

11. The portable electronic device of claim 10 in the form of a mobile phone, a portable global positioning system receiver, an electronic book reader, a radio, a camera, a portable music player, a laptop computer, or a portable game player
